(19) United States
(12) Patent Application Publication
(10) Pub. No.: US 2026/0307484 A1
(43) Pub. Date: Oct. 8, 2026

(54) INTEGRATED HEAD-UP DISPLAY

(71) Applicants: HYUNDAI MOTOR COMPANY, Seoul (KR); KIA CORPORATION, Seoul (KR)

(72) Inventors: Fuyuan Tang, Yantai (CN); Da Lin Zheng, Yantai (CN); Yu Fei Sun, Yantai (CN)

(73) Assignees: HYUNDAI MOTOR COMPANY, Seoul (KR); KIA CORPORATION, Seoul (KR)

(21) Appl. No.: 19/640,825

(22) Filed: Apr. 7, 2026

(30) Foreign Application Priority Data
Apr. 7, 2025 (CN) 202510428337.0

(51) Int. Cl. B60K 35/231; B60K 35/28; G02B 27/01

(52) U.S. Cl. CPC B60K 35/231; B60K 35/28; G02B 27/0101; G02B 27/0149; G02B 27/0179; B60K 2360/166; B60K 2360/175; G02B 2027/013; G02B 2027/0154

(57) ABSTRACT

An integrated head-up display includes a display including a first display area and a second display area, in which the first display area is configured to project a first image, and the second display area is configured to project a second image; a first reflector reflecting the second image projected from the second display area; a second reflector reflecting the second image reflected by the first reflector; a third reflector reflecting the second image reflected by the second reflector; and a windshield including a first projection area and a second projection area. The first image projected from the first display area is incident on the first projection area of the windshield, and the second image reflected by the third reflector is incident on the second projection area of the windshield.

### CROSS-REFERENCE TO RELATED APPLICATION

This application claims priority to and the benefit of Chinese Patent Application No. 202510428337.0 under 35 U.S.C. § 119, filed on Apr. 7, 2025, in the Chinese National Intellectual Property Administration, the entire disclosure of which is incorporated herein by reference.

### TECHNICAL FIELD

The present disclosure relates generally to an integrated head-up display that integrates a panoramic head-up display and a windshield-type head-up display.

### BACKGROUND

As related technologies advance, a head-up display (HUD) is increasingly being applied to a vehicle. A general HUD includes both a panoramic head-up display (P-HUD) and a windshield-type head-up display (W-HUD).

The panoramic head-up display (P-HUD) projects an image onto a black silk-screen region located at a lower portion of a windshield in front of a driver. In the case of the P-HUD, because the area of the projection region is relatively small and the position of the projection region is relatively fixed, an amount of information that the P-HUD projects is limited. In addition, since the projection region is black, and the contrast of the image projected by the P-HUD is high, the driver may not miss information projected by the P-HUD. Based on the characteristics of the P-HUD, the P-HUD is suitable for projecting information that has high priority related to vehicle driving and requires a small display area.

The windshield-type head-up display (W-HUD) projects an image onto a transparent glass region located at an upper portion of the windshield in front of the driver. In the case of the W-HUD, because the area of the projection region is relatively large and the position of the projection region is relatively flexible, an amount of information that the W-HUD projects is large. In addition, since the projection region is transparent glass, the contrast of the image projected by the W-HUD is limited, and thus the projection region is easily affected by the brightness of an external environment. Accordingly, the driver may miss the information projected by the W-HUD. Based on the characteristics of the W-HUD, the W-HUD is suitable for projecting information that has low importance or priority related to the vehicle driver and requires a large display area.

In particular, the P-HUD and the W-HUD differ in the types of information suitable for projection. However, when the P-HUD and the W-HUD are simultaneously installed in a vehicle, an occupied space increases and manufacturing costs become high.

The above information disclosed in this Background section is only for enhancement of understanding of the background of the disclosure, and therefore it may contain information that does not form the prior art that is already known in this country to a person having ordinary skill in the art.

### SUMMARY

There is a need to propose a head-up display that may simultaneously realize the functions of the P-HUD and the W-HUD, and has a compact structure and a low manufacturing cost.

An embodiment of the present disclosure provides an integrated head-up display that integrates a panoramic head-up display and a windshield-type head-up display.

According to one aspect of the present disclosure, an integrated head-up display includes a display including a first display area and a second display area, in which the first display area is configured to project a first image and the second display area is configured to project a second image; a first reflector reflecting the second image projected from the second display area; a second reflector reflecting the second image reflected by the first reflector; a third reflector reflecting the second image reflected by the second reflector; and a windshield including a first projection area and a second projection area. The first image projected from the first display area is incident on the first projection area of the windshield, and the second image reflected by the third reflector is incident on the second projection area of the windshield.

The first display area may be provided adjacent to or in front of the second display area. The first projection area may be a black screen area, and the second projection area may be positioned on the windshield positioned above the first projection area. The first image may include first information related to vehicle driving. The second image may include second information related to vehicle driving. An importance or priority of the first information may be higher than an importance or a priority of the second information.

The display may be disposed at a first predetermined angle with respect to a vertical direction so that the first image projected from the first display area of the display may be directly incident on the first projection area of the windshield. The first reflector may be provided between the first display area and the second display area of the display and is disposed at a second predetermined angle with respect to the display so that the second image projected from the second display area of the display may be incident on the first reflector and reflected toward the second reflector. The second reflector may be provided at an upper rear side of the second display area and is disposed at a third predetermined angle with respect to the vertical direction so that the second image reflected by the first reflector may be incident on the second reflector and reflected toward the third reflector. The third reflector may be provided between the first reflector and the second reflector and is positioned lower than the first reflector and the second reflector so that the second image reflected by the second reflector may be incident on the third reflector and reflected toward the second projection area.

The integrated head-up display may further include a shaft located on the third reflector (e.g., at the middle of the third reflector), in which the third reflector may be configured to be rotatable about the shaft; and a driving device connected to the shaft and configured to rotate the shaft.

The integrated head-up display may further include a controller, wherein the controller may be configured to adjust a projection position of the first image in the first projection area of the windshield by adjusting a position of the first image in the first display area of the display, and adjust a projection position of the second image in the second projection area of the windshield by controlling the driving device to rotate the shaft.

The integrated head-up display may further include a first light source provided below the first display area of the display to illuminate the first display area of the display, a second light source provided below the second display area of the display to illuminate the second display area of the display, a first radiator disposed adjacent to (e.g., below) the first light source to dissipate heat from the first light source; and a second radiator disposed adjacent to (e.g., below) the second light source to dissipate heat from the second light source.

The integrated head-up display may further include a case. The case may include a first window and a second window, and the first image projected from the first display area of the display may be transmitted through the first window, and the second image projected from the second display area of the display may be transmitted through the second window.

Each of the first and second reflectors may be a flat reflector, and the third reflector may be a curved reflector.

The first information may be a cluster information of the vehicle, a notification information related to an autonomous driving, or a notification message related to an autonomous driving setting state.

The second information may be a navigation information, a forward road information, a distance to a leading vehicle, a pedestrian notification, a lane keeping assist notification, or a forward collision warning.

The third reflector may be a concavely curved reflector facing toward the second reflector.

The first projection area may be located below the second projection area.

The case may have an internal space to accommodate the display, the first reflector, the second reflector, the third reflector, the first light source, and the second light source.

According to an embodiment of the present disclosure, functions of a P-HUD and a W-HUD may be realized by integrating the P-HUD and the W-HUD, and a structure is compact and a cost of manufacturing is low.

In addition, effects that may be obtained or expected from embodiments of the present disclosure are directly or suggestively described in the following detailed description. In particular, various effects expected from embodiments of the present disclosure are described in the following detailed description.

### BRIEF DESCRIPTION OF THE DRAWINGS

The above and other objects, features, and other advantages of the present disclosure should be more clearly understood from the following detailed description taken in conjunction with the accompanying drawings.

FIG. 1 is a schematic perspective view illustrating an integrated head-up display according to an embodiment of the present disclosure.

FIG. 2 is another schematic perspective view illustrating the integrated head-up display according to an embodiment of the present disclosure.

FIG. 3 is still another schematic perspective view illustrating the integrated head-up display according to an embodiment of the present disclosure.

FIG. 4 is a schematic view illustrating a display effect of the integrated head-up display according to an embodiment of the present disclosure.

FIG. 5 is a schematic perspective view illustrating a case of the integrated head-up display according to an embodiment of the present disclosure.

FIG. 6 is a schematic block diagram illustrating the integrated head-up display according to an embodiment of the present disclosure.

FIG. 7 is a schematic view illustrating an optical path of the integrated head-up display according to an embodiment of the present disclosure.

It should be understood that the drawings simply illustrate features in order to explain the basic principles of the present disclosure, and are not necessarily drawn to scale. In the drawings, the same reference numerals denote the same or equivalent parts.

### DETAILED DESCRIPTION

It should be understood that the term “vehicle” or “vehicular”, or other similar terms as used herein generally include vehicles such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (fuels derived from resources other than petroleum).

Although an embodiment is described as performing an example process using a plurality of units, it should be understood that the example processes may also be performed by one or a plurality of modules. In addition, it should be understood that the terms “control unit,” “controller,” or similar terms refer to a hardware device including a memory and a processor. The memory is configured to store modules, and the processor is specifically configured to execute the modules to complete one or more processes which are described further below.

Terms such as “unit,” “portion,” “part,” and the like may be used to describe various components, but the components should not be limited by the terms. The above-described terms may refer to a term indicating not only a physically/visually distinct component, but also a function or component of a corresponding portion even in case that they are not clearly divided or partitioned.

The terminology used herein is for the purpose of describing particular embodiments only and is not to be limiting of the embodiments. As used herein, the singular forms “a,” “an,” and “the” are intended to include the plural forms as well, unless the context clearly indicates otherwise. As used herein, the term “and/or” includes any one and any combination of any two or more of the associated listed items. It is further understood that the terms “including,” “having,” “comprises” and/or “comprising,” when used in this disclosure, specify the presence of stated features, integers, operations, operations, elements, components or a combination thereof, but do not preclude the presence or addition of one or more other features, integers, operations, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one having ordinary skill in the art.

When a component, unit, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

When a component is referred to as being “connected” or “coupled” to another component, the component may be directly connected or coupled to the other component or there may be other components therebetween.

Hereinafter, an integrated head-up display according to an embodiment of the present disclosure is described with reference to the accompanying drawings.

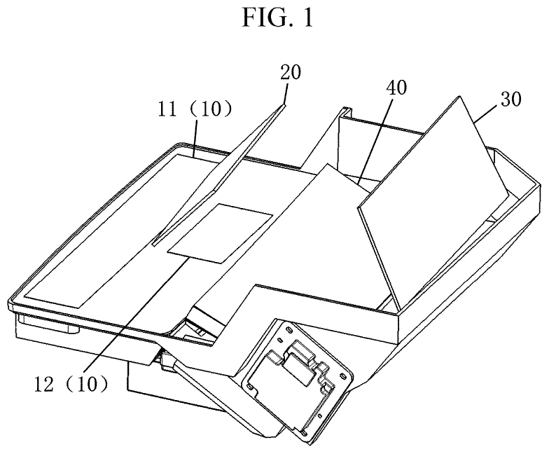

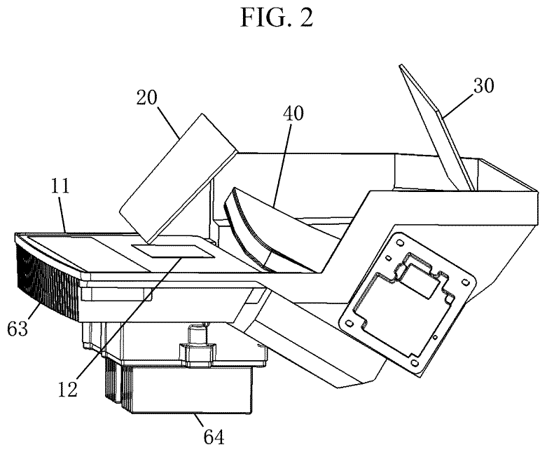

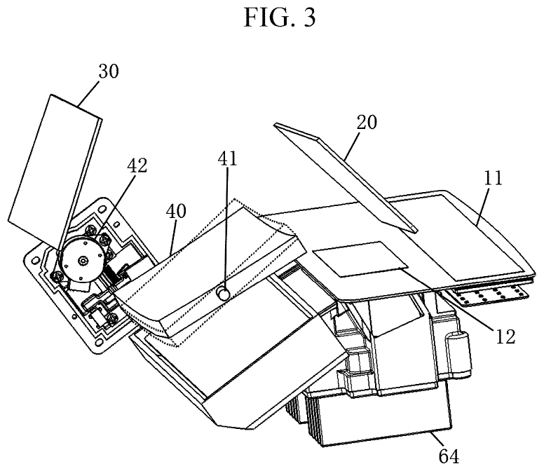

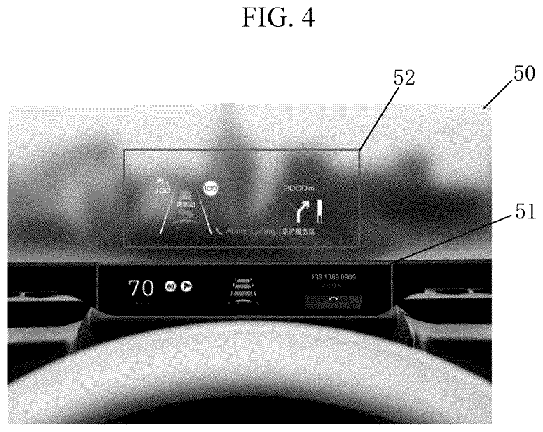

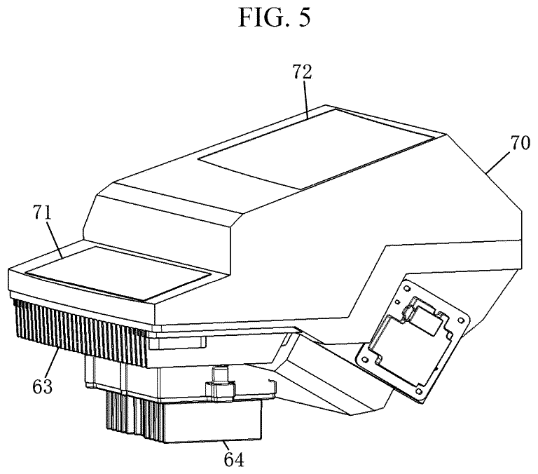

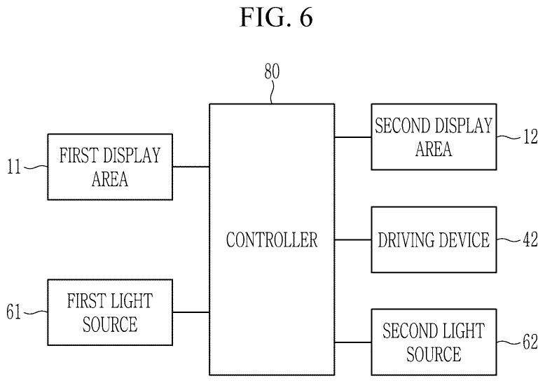

FIG. 1 is a schematic perspective view illustrating an integrated head-up display according to an embodiment of the present disclosure, FIG. 2 is another schematic perspective view illustrating the integrated head-up display according to an embodiment of the present disclosure, FIG. 3 is still another schematic perspective view illustrating the integrated head-up display according to an embodiment of the present disclosure, FIG. 4 is a schematic view illustrating a display effect of the integrated head-up display according to an embodiment of the present disclosure, FIG. 5 is a schematic perspective view illustrating a case of the integrated head-up display according to an embodiment of the present disclosure, and FIG. 6 is a schematic block diagram illustrating the integrated head-up display according to an embodiment of the present disclosure.

FIGS. 1-3 are perspective views illustrating an integrated head-up display according to an embodiment of the present disclosure.

As illustrated in FIGS. 1-3, an integrated head-up display according to an embodiment of the present disclosure may include a display 10, a first reflector 20, a second reflector 30, and a third reflector 40.

In an embodiment, the display 10 may be a display device for projecting an image. For example, the display 10 may include a thin-film transistor (TFT) display, a liquid crystal display (LCD), a digital light processing (DLP) display, a liquid crystal on silicon (LCOS) display, and the like. The display 10 may include a first display area 11 and a second display area 12. The first display area 11 may project a first image, and the second display area 12 may project a second image different from the first image.

The first display area 11 may be provided in front of the second display area 12. In this case, the front-rear direction refers to a longitudinal direction with respect to a vehicle. In particular, the first display area 11 may be disposed closer to a front windshield, and the second display area 12 may be disposed closer to a driver.

The display 10 may be inclined toward the front windshield. Specifically, the display 10 may be disposed at a first predetermined angle with respect to a vertical direction so that the first image projected from the first display area 11 of the display 10 may be incident (or directly incident) on a windshield 50 In this case, an angle between a display plane of the display 10 and the vertical direction may be referred as the first predetermined angle.

The vertical direction may refer to a height direction of the vehicle. For example, the first predetermined angle may be within a range of about 60° to about 70°.

The first reflector 20 may be a flat reflector. The first reflector 20 may be provided between the first display area 11 and the second display area 12 of the display 10. The first reflector 20 may be inclined toward the second display area 12. Specifically, the first reflector 20 may be disposed at a second predetermined angle with respect to the display 10 so that the second image projected from the second display area 12 of the display 10 is incident on the first reflector 20 and reflected toward the second reflector 30. In this case, an angle between a plane in which the first reflector 20 is positioned and the vertical direction may be the second predetermined angle. For example, the second predetermined angle may be within a range of about 55° to about 65°.

The second reflector 30 may be a flat reflector. The second reflector 30 may be provided at the rear of the second display area 12. The second reflector 30 may be inclined toward the second display area 12. Specifically, the second reflector 30 may be disposed at a third predetermined angle with respect to the vertical direction so that the second image reflected by the first reflector 20 is incident on the second reflector 30 and reflected toward the third reflector 40. For example, the third predetermined angle may be within a range of about 2° (degrees) to about 8° (degrees). In this case, an angle between a plane where the third reflector 40 is positioned and the vertical direction may be the third predetermined angle.

The third reflector 40 may be a curved reflector. For example, the third reflector 40 may be a concavely curved reflector. In this case, the third reflector 40 may be curved inward facing the second reflector 20. The third reflector 40 may be provided between the first reflector 20 and the second reflector 30, and may be positioned at a lower position than the first reflector 20 and the second reflector 30. The third reflector 40 may be inclined toward the second reflector 30. Specifically, the third reflector 40 may be disposed so that the second image reflected by the second reflector 30 is incident on the third reflector 40 and reflected toward a second projection area 52.

In addition, the third reflector 40 may have a predetermined magnification ratio so that the second image reflected by the third reflector 40 is magnified by a predetermined multiple. For example, the predetermined multiple may be in a range of about 2 to about 6 times.

Furthermore, an integrated head-up display according to an embodiment of the present disclosure may include the windshield 50 as illustrated in FIG. 4, and the windshield 50 may be a front windshield of a vehicle. The windshield 50 may include a first projection area 51 and a second projection area 52 disposed above the first projection area 51.

The first projection area 51 may be a black screen area. The first image projected from the first display area 11 may be incident (or directly incident) on the first projection area 51. Accordingly, a display effect identical to that of a Panoramic Head-Up Display (P-HUD) may be implemented through the first display area 11 and the first projection area 51.

The second projection area 52 may be a portion of the windshield 50 positioned above the first projection area 51. The second image reflected by the third reflector 40 may be incident on the second projection area 52. Accordingly, a display effect identical to that of a Windshield-type Head-Up Display (W-HUD) may be implemented through the second display area 12, the first reflector 20, the second reflector 30, the third reflector 40, and the second projection area 52.

Since the first image is projected (or directly projected) onto the first projection area 51 of the windshield 50 and the second image is enlarged by the third reflector 40 and projected onto the second projection area 52 of the windshield 50, an area of the first display area 11 for displaying the first image may be larger than an area of the second display area 12 for displaying the second image.

The first image projected onto the first projection area 51 may include first information related to vehicle driving. The second image projected onto the second projection area 52 may include second information related to vehicle driving. The importance or priority of the first information may be higher than that of the second information. In other words, the first information may be more important or have a higher priority than the second information.

Since the first projection area 51 is a black screen area, and the first image is not affected by the brightness of an external environment and has high contrast, the first image may be used to display the first information having high importance (or priority). In addition, since the second projection area 52 is transparent glass, and the second image may be affected by the brightness of the external environment and has low contrast, the second image may be used to display the second information having lower importance (or priority).

For example, the first information may include cluster information of the vehicle (for example, information regarding vehicle speed, engine rotation speed, motor rotation speed, driving range, remaining fuel level, failure indicator lights, status indicator lights, and the like), notification information related to autonomous driving (for example, information regarding an emergency notification of a dangerous situation, a Highway Driving Assist (HDA) warning indicator, a Lane Departure Warning (LDW) indicator, a Lane Keeping Assist (LKA) warning indicator, and the like), and notification messages related to an autonomous driving setting state (for example, messages regarding an autonomous driving assistance function readiness notification, an autonomous assistance steering notification, an inter-vehicle distance notification, a driving state notification, an autonomous driving inter-vehicle distance notification, and the like).

For example, the second information may include information to be combined with actual road conditions, such as navigation information, road information ahead, a distance to a leading vehicle, a pedestrian notification, a lane keeping assist notification, and a forward collision warning.

Additionally, as illustrated in FIG. 3, the integrated head-up display according to the embodiment of the present disclosure may further include a shaft 41 and a driving device 42.

The shaft 41 may be installed on the third reflector 40. For example, the shaft 41 may be installed in the middle of the third reflector 40 so that the third reflector 40 is configured to be rotatable about the shaft 41.

The driving device 42 may be connected to the shaft 41 to rotate the shaft 41. For example, the driving device 42 may be a motor. However, it is not limited thereto. When the driving device 42 is operated, the driving device 42 may rotate the shaft 41, and the third reflector 40 may rotate about the shaft 41. Accordingly, a position where the second image reflected by the third reflector 40 is incident on the second projection area 52 may be changed.

In addition, as illustrated in FIG. 2, FIG. 5, and FIG. 6, the integrated head-up display according to the embodiment of the present disclosure may further include a first light source 61, a second light source 62, a first radiator 63, and a second radiator 64.

The first display area 11 and the second display area 12 of the display 10 may be used to display different images, respectively. Light sources may be respectively provided to the first display area 11 and the second display area 12. The first light source 61 may be provided below the first display area 11 of the display 10, so that the first light source 61 is used to illuminate the first display area 11 of the display 10. The second light source 62 may be provided below the second display area 12 of the display 10, so that the second light source 62 is used to illuminate the second display area 12 of the display 10.

Since the second image is more affected by the brightness of the external environment compared to the first image, the brightness of the second light source 62 used for the second image may be set higher than the brightness of the first light source 61 used for the first image.

For example, the first light source 61 and the second light source 62 may be light emitting diodes (LEDs). To ensure the luminous efficiency of the light sources, radiators may be provided for the first light source 61 and the second light source 62, respectively. The first radiator 63 may be located adjacent to the first light source 61 to dissipate heat from the first light source 61, and the second radiator 64 may be located adjacent to the second light source 62 to dissipate heat from the second light source 62. In this case, the first radiator 63 may be provided below the first light source 61, so that the first radiator 63 is used to dissipate heat from the first light source 61. The second radiator 64 may be provided below the second light source 62, so that the second radiator 64 is used to dissipate heat from the second light source 62.

Additionally, the integrated head-up display according to the embodiment of the present disclosure may further include a case 70. The case 70 may have an internal space for accommodating the display 10, the first reflector 20, the second reflector 30, the third reflector 40, the first light source 61, and the second light source 62. The first radiator 63 and the second radiator 64 may be provided outside the case 70 and attached thereto. In this case, the first radiator 63 may be disposed above the second radiator 64.

The case 70 may include a first window 71 and a second window 72. The first image projected from the first display area 11 of the display 10 may be transmitted through the first window 71. The second image projected from the second display area 12 of the display 10 may be transmitted through the second window 72. Since the position of the projection area of the second image (second projection area 52) is located higher than the position of the projection area of the first image (first projection area 51), the height of the first window 71 and the height of the second window 72 may be different. For example, the second window 72 may be provided at a higher position than the first window 71. In this case, the second window 72 may be positioned above the first window 71.

Additionally, as illustrated in FIG. 6, the integrated head-up display according to the embodiment of the present disclosure may further include a controller 80. The controller 80 may be configured to control the first display area 11 and the second display area 12 of the display 10 in order to display the first image and the second image. Additionally, the controller 80 may be configured to control the first light source 61 and the second light source 62 to illuminate the first display area 11 and the second display area 12.

Furthermore, the controller 80 may be configured to adjust the projection position in the first projection area 51 of the first image, and to adjust the projection position (particularly the projection height) of the second image in the second projection area 52.

Since different drivers have different heights and body types, the projection positions of the first and second images suitable for each driver may be also different. Accordingly, the projection positions of the first and second images may be adjustable.

The controller 80 may be configured to adjust the position of the first image in the first display area 11 of the display 10, thereby adjusting the projection position of the first image in the first projection area 51 of the windshield 50. Additionally, the controller 80 may be configured to adjust the projection position of the second image in the second projection area 52 of the windshield 50 by controlling the driving device 42 to rotate the shaft 41. In the case of a vehicle equipped with a seat memory function (IMF), the controller 80 may be configured to record and store the corresponding projection positions of the first and second images for each individual driver.

Specifically, since the first image is projected directly onto the first projection area 51 of the windshield 50, the projection position (for example, vertical and horizontal positions) of the first image in the first projection area 51 of the windshield 50 may be adjusted by adjusting the position of the first image in the first display area 11 of the display 10.

However, in the case of the second image, since the area of the second display area 12 for displaying the second image is small, there may not be much margin (or space) in the second display area 12 of the display 10 for adjusting the position of the second image. More importantly, since the second image is incident on the second projection area 52 of the windshield 50 only after multiple reflections through a plurality of reflectors (particularly, reflection by the third reflector 40 used as a curved reflector), even a slight adjustment of the position of the second image in the second display area 12 of the display 10 may effectively affect the projection position of the second image in the second projection area 52 of the windshield 50, and may even cause image distortion.

Therefore, for the second image, the projection position of the second image in the second projection area 52 of the windshield 50 may be adjusted primarily by changing the angle of the third reflector 40. Specifically, the controller 80 may control the driving device 42 to rotate the shaft 41, so that the angle of the third reflector 40 with respect to the second projection area 52 is changed as the third reflector 40 rotates about the shaft 41. Thus, the projection position (for example, vertical position) of the second image in the second projection area 52 of the windshield 50 may be adjusted.

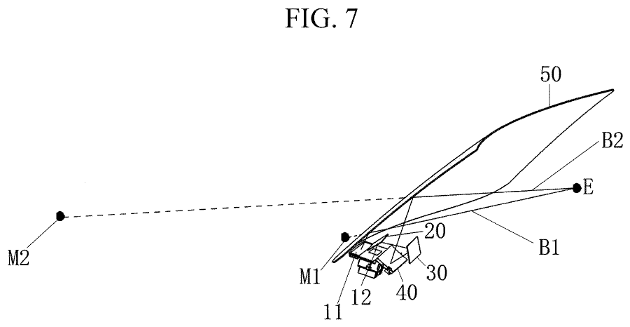

FIG. 7 is a schematic view illustrating an optical path of the integrated head-up display according to an embodiment of the present disclosure. Point E may represent the position of the driver's eye, a first position M1 may represent a position where a virtual image finally formed by the first image is positioned, and a second position M2 may represent a position where a virtual image finally formed by the second image is positioned.

As illustrated in FIG. 7, a first beam B1 of the first image projected from the first display area 11 of the display 10 may be incident (or directly incident) on the first projection area 51 of the windshield 50 toward the front upper side. When observed from the driver's viewpoint, the virtual image of the projected first image may be formed at the first position M1 in front of the windshield 50.

A second beam B2 of the second image projected from the second display area 12 of the display 10 may be incident on the first reflector 20 installed between the first display area 11 and the second display area 12 toward the front upper side, and may be reflected by the first reflector 20. The second beam B2 reflected by the first reflector 20 may be incident on the second reflector 30 installed at a rear upper side of the first reflector 20 toward the rear upper side, and may be reflected by the second reflector 30. The second beam B2 reflected by the second reflector 30 may be incident on the third reflector 40 installed between the first reflector 20 and the second reflector 30 toward the front lower side. The second beam B2 may be reflected by the third reflector 40 and simultaneously magnified by a predetermined magnification by the third reflector 40. The magnified second beam B2 may be incident on the second projection area 52 of the windshield 50 toward the front upper side. When observed from the driver's viewpoint, the virtual image of the projected second image may be formed at the second position M2 in front of the windshield 50.

According to the conventional art, a P-HUD and a W-HUD are provided separately, where the P-HUD includes one display for displaying an image and the W-HUD also includes one display for displaying an image. Such a configuration not only occupies a large space but also incurs high costs due to the use of two displays.

The integrated head-up display according to the embodiment of the present disclosure may integrate the P-HUD and the W-HUD to realize the functions of both the P-HUD and the W-HUD, and have a compact structure and a low manufacturing cost.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. An integrated head-up display, comprising:
a display including a first display area and a second display area, the first display area configured to project a first image and the second display area configured to project a second image;
a first reflector configured to reflect the second image projected from the second display area;
a second reflector configured to reflect the second image reflected by the first reflector;
a third reflector configured to reflect the second image reflected by the second reflector; and
a windshield including a first projection area and a second projection area,
wherein the first image projected from the first display area is incident on the first projection area of the windshield, and the second image reflected by the third reflector is incident on the second projection area of the windshield.

2. The integrated head-up display of claim 1, wherein the first display area is provided adjacent to the second display area,
the first projection area is a black screen area, and the second projection area is positioned on the windshield,
the first image includes first information related to vehicle driving,
the second image includes second information related to the vehicle driving, and
a priority of the first information is higher than a priority of the second information.

3. The integrated head-up display of claim 2, wherein the display is disposed at a first predetermined angle with respect to a vertical direction so that the first image projected from the first display area of the display is directly incident on the first projection area of the windshield,
the first reflector is provided between the first display area and the second display area of the display and is disposed at a second predetermined angle with respect to the display so that the second image projected from the second display area of the display is incident on the first reflector and reflected toward the second reflector,
the second reflector is provided at an upper rear side of the second display area and is disposed at a third predetermined angle with respect to the vertical direction so that the second image reflected by the first reflector is incident on the second reflector and reflected toward the third reflector, and
the third reflector is provided between the first reflector and the second reflector and is positioned lower than the first reflector and the second reflector so that the second image reflected by the second reflector is incident on the third reflector and reflected toward the second projection area.

4. The integrated head-up display of claim 1, further comprising:
a shaft located on the third reflector, the third reflector configured to be rotatable about the shaft; and
a driving device connected to the shaft and configured to rotate the shaft.

5. The integrated head-up display of claim 4, further comprising a controller,
wherein the controller is configured to:
adjust a projection position of the first image in the first projection area of the windshield by adjusting a position of the first image in the first display area of the display; and
adjust a projection position of the second image in the second projection area of the windshield by controlling the driving device to rotate the shaft.

6. The integrated head-up display of claim 1, further comprising:
a first light source provided below the first display area of the display to illuminate the first display area of the display;
a second light source provided below the second display area of the display to illuminate the second display area of the display;
a first radiator disposed adjacent to the first light source to dissipate heat from the first light source; and
a second radiator disposed adjacent to the second light source to dissipate heat from the second light source.

7. The integrated head-up display of claim 6, further comprising a case,
wherein
the case includes a first window and a second window, and
the first image projected from the first display area of the display is transmitted through the first window, and the second image projected from the second display area of the display is transmitted through the second window.

8. The integrated head-up display of claim 1, wherein each of the first and second reflectors is a flat reflector, and the third reflector is a curved reflector.

9. The integrated head-up display of claim 2, wherein the first information is cluster information of the vehicle, notification information related to autonomous driving, or a notification message related to an autonomous driving setting state.

10. The integrated head-up display of claim 9, wherein the second information is navigation information, forward road information, a distance to a leading vehicle, a pedestrian notification, a lane keeping assist notification, or a forward collision warning.

11. The integrated head-up display of claim 8, wherein the third reflector is a concavely curved reflector facing toward the second reflector.

12. The integrated head-up display of claim 2, wherein the first projection area is located below the second projection area.

13. The integrated head-up display of claim 7, wherein the case has an internal space to accommodate the display, the first reflector, the second reflector, the third reflector, the first light source, and the second light source.
